(19) United States
(12) Patent Application Publication
(10) Pub. No.: US 2023/0146502 A1
(43) Pub. Date: May 11, 2023

(54) LIQUID-CRYSTAL POLYESTER AND LIQUID-CRYSTAL POLYESTER FILM

(71) Applicant: SUMITOMO CHEMICAL COMPANY, LIMITED, Tokyo (JP)

(72) Inventors: Shohei AZAMI, Tsukuba-shi (JP); Nozomi MASUI, Tsukuba-shi (JP)

(21) Appl. No.: 17/918,770

(22) PCT Filed: Apr. 7, 2021
(86) PCT No.: PCT/JP2021/014753

§ 371 Date: Oct. 13, 2022

(30) Foreign Application Priority Data
Apr. 20, 2020 (JP) 2020-074699

(51) Int. Cl. C08G 63/06

(52) U.S. Cl. CPC C08G 63/06

(57) ABSTRACT

A liquid crystal polyester comprising a structural unit derived from 6-hydroxy-2-naphthoic acid, wherein in thermal extraction GC-MS analysis of the liquid crystal polyester under the following measuring conditions, the relative content of the following impurity component determined from the GC peak area in the total ion chromatogram using methyl 6-hydroxy-2-naphthoate as a standard sample is 50 ppm or less based on the mass of the liquid crystal polyester, and the impurity component has main peaks at m/z=228, 186, 171, and 143 in the MS spectrum chart and a retention time detected in the range of 11.5 to 12.5 min in the total ion chromatogram.

### TECHNICAL FIELD

The present invention relates to a liquid crystal polyester and a liquid crystal polyester film.

This application claims priority to Japanese Patent Application No. 2020-074699, filed on Apr. 20, 2020, the disclosure of which is incorporated herein by reference in its entirety.

### BACKGROUND ART

As insulation films for multilayer printed circuit boards on which electronic parts are mounted or flexible printed wiring boards, liquid crystal polyester films have been proposed.

For example, liquid crystal polyester films for flexible printed wiring boards are produced by casting a liquid composition comprising a liquid crystal polyester and a solvent onto a support and removing the solvent from the cast product (see Patent Literatures 1 and 2).

### CITATION LIST

### Patent Literature

Patent Literature 1: Japanese Patent No. 4470390
Patent Literature 2: Japanese Patent No. 4479355

### SUMMARY OF INVENTION

### Technical Problem

The liquid crystal polyester films comprising a structural unit derived from 6-hydroxy-2-naphthoic acid that are disclosed in Patent Literatures 1 and 2 have excellent insulation performance but tend to be colored. The colored liquid crystal polyester films not only have poor appearance but also make it difficult to visually check for contamination of foreign matter when used on circuit boards.

The present invention has been devised in view of the problems described above, and an object thereof is to provide a liquid crystal polyester and a liquid crystal polyester film in both of which coloration is suppressed.

### Solution to Problem

The present invention has the following aspects.

[1] A liquid crystal polyester comprising a structural unit derived from 6-hydroxy-2-naphthoic acid, wherein
in thermal extraction GC-MS analysis of the liquid crystal polyester under the following measuring conditions, the relative content of an impurity component determined from the GC peak area in the total ion chromatogram using methyl 6-hydroxy-2-naphthoate as a standard sample is 50 ppm or less based on the mass of the liquid crystal polyester, and the impurity component has main peaks at m/z=228, 186, 171, and 143 in the MS spectrum chart and a retention time detected in the range of 11.5 to 12.5 min in the total ion chromatogram:

### (Measuring Conditions of Thermal Extraction GC-MS)

Thermal extraction temperature: 300° C. for 15 min;
ITF temperature: 320° C.;
Column: 0.25 mm diameter×30 m (stationary phase: 5% diphenyl dimethyl polysiloxane, film thickness: 0.25 μm);
Inlet temperature: 320° C.;
Split ratio: 100:1;
Oven temperature: 50° C. (1 min), 20° C./min, then 350° C. (5 min);
Carrier gas: Helium at 103.3 mL/min;
Electron ionization energy: 1435 eV;
Measuring mass range: m/z 35 to 600;
MS interface temperature: 350° C.; and
Solvent waiting time: 4 min.
[2] The liquid crystal polyester according to [1] above, further comprising a structural unit derived from an aromatic dicarboxylic acid and a structural unit (u3) represented by formula (3) below:

—X—Ar³—Y— (3)

wherein Ar³ represents a 1,4-phenylene group or a 1,3-phenylene group, X represents —NH—, and Y represents —O— or —NH—, provided that the hydrogen atoms of the group represented by Ar³ are each independently optionally replaced by a halogen atom, an alkyl group having a carbon number of 1 to 10, or an aryl group having a carbon number of 6 to 20.
[3] The liquid crystal polyester according to [2] above, wherein the structural unit derived from the aromatic dicarboxylic acid comprises a structural unit (u2) represented by formula (2) below:

—CO—Ar²—CO— (2)

wherein Ar² represents a 1,4-phenylene group, a 1,3-phenylene group, or a 2,6-naphthalenediyl group, provided that the hydrogen atoms of the group represented by Ar² are each independently optionally replaced by a halogen atom, an alkyl group having a carbon number of 1 to 10, or an aryl group having a carbon number of 6 to 20.
[4] The liquid crystal polyester according to [3] above, wherein the Ar² is 1,3-phenylene, Ar³ is 1,4-phenylene, and Y is —O—.
[5] A liquid crystal polyester film comprising a structural unit derived from 6-hydroxy-2-naphthoic acid, a structural unit derived from an aromatic dicarboxylic acid, and a structural unit (u3) represented by formula (3) below, wherein when the color values of the liquid crystal polyester film are evaluated in the CIE LAB color space, the L* value is 60 or more, and the a* value is 9.0 or less:

—X—Ar³—Y— (3)

wherein Ar³ represents a 1,4-phenylene group or a 1,3-phenylene group, X represents —NH—, and Y represents —O— or —NH—, provided that the hydrogen atoms of the group represented by Ar³ are each independently optionally replaced by a halogen atom, an alkyl group having a carbon number of 1 to 10, or an aryl group having a carbon number of 6 to 20.
[6] The liquid crystal polyester film according to [5] above, wherein the structural unit derived from the aromatic dicarboxylic acid comprises the structural unit (u2) represented by formula (2) below:

—CO—Ar²—CO— (2)

wherein Ar² represents a 1,4-phenylene group, a 1,3-phenylene group, or a 2,6-naphthalenediyl group, provided that the hydrogen atoms of the group represented by Ar² are each independently optionally replaced by a halogen atom, an alkyl group having a carbon number of 1 to 10, or an aryl group having a carbon number of 6 to 20.
[7] The liquid crystal polyester film according to [6] above, wherein the Ar² is 1,3-phenylene, Ar³ is 1,4-phenylene, and Y is —O—.

### Advantageous Effects of Invention

The present invention can provide a liquid crystal polyester and a liquid crystal polyester film in both of which coloration is suppressed.

### BRIEF DESCRIPTION OF DRAWINGS

FIG. 1 is a total ion chromatogram in the thermal extraction GC-MS analysis of the liquid crystal polyester of Example 4.

FIG. 2 (upper) is an MS spectrum at an elution time of 12.02 min in the total ion chromatogram in the thermal extraction GC-MS analysis of the liquid crystal polyester of Example 4. FIG. 2 (lower) is an MS spectrum of a standard sample of 1-acetyl-2-acetoxynaphthalene.

FIG. 3 (upper) is a total ion chromatogram in the thermal extraction GC-MS analysis of methyl 6-hydroxy-2-naphthoate as a control standard sample, and FIG. 3 (lower) is an MS spectrum thereof.

### DESCRIPTION OF EMBODIMENTS

### <Liquid Crystal Polyester>

The liquid crystal polyester of this embodiment comprises a structural unit derived from 6-hydroxy-2-naphthoic acid.

The liquid crystal polyester is a liquid crystal polyester that exhibits liquid crystallinity in a molten state and preferably melts at a temperature of 450° C. or less. The liquid crystal polyester may be a liquid crystal polyester amide, a liquid crystal polyester ether, a liquid crystal polyester carbonate, or a liquid crystal polyester imide. The liquid crystal polyester is preferably a fully aromatic liquid crystal polyester having only structural units derived from aromatic compounds as raw material monomers.

In this description, “being derived from” means that the chemical structure of a functional group contributing to polymerization is changed for the polymerization of the raw material monomers, and no other structural changes occur.

In the thermal extraction GC-MS analysis of the liquid crystal polyester under the following measuring conditions, the relative content of an impurity component determined from the GC peak area of the total ion chromatogram using methyl 6-hydroxy-2-naphthoate as a standard sample is 50 ppm or less based on the mass of the liquid crystal polyester, the impurity component has main peaks at m/z=228, 186, 171, and 143 in the MS spectrum chart and a retention time detected in the range of 11.5 to 12.5 min in the total ion chromatogram.

### (Measuring Conditions of Thermal Extraction GC-MS)

Thermal extraction temperature: 300° C. for 15 min
ITF temperature: 320° C.
Column: 0.25 mm diameter×30 m (stationary phase: 5% diphenyl dimethyl polysiloxane, film thickness: 0.25 μm)
Inlet temperature: 320° C.
Split ratio: 100:1
Oven temperature: 50° C. (1 min), 20° C./min, then 350° C. (5 min)
Carrier gas: Helium at 103.3 mL/min
Electron ionization energy: 1435 eV
Measuring mass range: m/z 35 to 600
MS interface temperature: 350° C.
Solvent waiting time: 4 min

Thermal extraction GC-MS analysis is to analyze, by GC-MS (Gas Chromatography-Mass Spectrometry), a sample heated and extracted using a pyrolyzer as a pretreatment.

In the measuring conditions of thermal extraction GC-MS, the “thermal extraction temperature” represents the heating conditions of the pyrolyzer. The “ITF temperature” is the interface temperature of the pyrolyzer and is the temperature before the inlet into GC.

In the measuring conditions of thermal extraction GC-MS, the “column” represents the separation column in GC. The “inlet temperature” is the temperature of the inlet into GC. The “split ratio” represents the injection mode in GC. The “oven temperature” is the temperature of the GC oven. The “carrier gas” represents the carrier gas in GC and the flow rate thereof.

In the measuring conditions of thermal extraction GC-MS, the “electron ionization energy” represents the electron ionization energy of MS. The “measuring mass range” represents the MS measuring range in m/z (that is, mass-to-charge ratio). The “MS interface temperature” represents the temperature of the interface from GC to MS. The “solvent waiting time” represents the retention time during which MS analysis is not carried out until the solvent has passed through the separation column in GC.

In the pretreatment of polymer compounds using the pyrolyzer, the polymer compounds can be pyrolyzed, or pyrolysis of the polymer compounds can be suppressed to heat and extract trace components in the polymer compounds, depending on the heating conditions of the pyrolyzer. In the thermal extraction GC-MS analysis of the polymer compounds, the pyrolysis of the polymer compounds is suppressed to heat and extract trace components in the polymer compounds for GC-MS analysis by adjusting the heating conditions of the pyrolyzer.

In general, scan mode or SIM mode analysis is performed in GC-MS analysis. In the scan mode, a total ion chromatogram and a mass spectrometry result (that is, MS spectrum) of each peak appearing in the total ion chromatogram can be obtained. In the SIM mode, a chromatogram of only the specified mass can be obtained with high sensitivity.

The thermal extraction GC-MS analysis can be performed, for example, using a thermal extraction GC-MS device (gas chromatograph: HP6890, manufactured by Agilent Technologies Japan, Ltd., mass spectrometer: 5973N, manufactured by Agilent Technologies Japan, Ltd., pyrolysis heating furnace: PY-2020D, manufactured by Frontier Laboratories Ltd.).

When the liquid crystal polyester is analyzed by thermal extraction GC-MS under the aforementioned measuring conditions, the impurity component in the GC peak having main peaks of m/z=228, 186, 171, and 143 in the MS spectrum chart and a retention time detected in the range of 11.5 to 12.5 min in the total ion chromatogram is unspecified The impurity component is presumed to be 1-acetyl-2-acetoxynaphthalene (Mw=228), 2-acetyl-6-acetoxynaphthalene (Mw=228), or an isomer having the same molecular weight as above.

Here, Mw=228 means that Mw (that is, molecular weight) is within the range of 227.5 or more and less than 228.5. Hereinafter, when Mw (that is, molecular weight) is expressed as an integer, it represents a value in a similar range.

In this description, m/z=228 means that m/z (that is, mass-to-charge ratio) is within the range of 227.5 or more and less than 228.5 in the MS spectrum. Hereinafter, when m/z (that is, mass-to-charge ratio) is expressed as an integer, such as m/z=186, 171, and 143, it represents a value in a similar range.

In the MS spectrum chart of the GC peak in which the retention time in the total ion chromatogram is detected in the range of 11.5 to 12.5 min, m/z=228 is considered to represent the molecular weight (Mw=228) of the impurity component in the GC peak.

The peak at m/z=186 is considered to represent a fragment (m/z=186) formed by elimination of O═C═CH₂ (Mw=42) from the acetoxy group directly bonded to the naphthalene ring.

The peak at m/z=171 is considered to represent a fragment (m/z=171) formed by elimination of a CH₃ group (Mw=15) from the acetyl group.

The peak at m/z=143 is considered to represent a fragment (m/z=143) formed by further elimination of a C═O group (Mw=28).

The study of the inventors revealed that the amount of the impurity component in the GC peak has a strong correlation with the degree of coloring of the liquid crystal polyester in thermal extraction GC-MS analysis of the liquid crystal polyester under the aforementioned measuring conditions. That is, as the amount of the impurity component in the GC peak decreases, the coloration of the liquid crystal polyester is more suppressed, and when the color values of the liquid crystal polyester are evaluated in the CIE LAB color space, the L* value tends to increase, and the a* value tends to decrease.

The relative content of the impurity component can be evaluated from the area of the GC peak using methyl 6-hydroxy-2-naphthoate as a standard sample by the following calculation.

That is, the liquid crystal polyester (weighing value: A₁ [mg]) is poured into a measuring cup for thermal extraction GC-MS devices and inserted into a pyrolysis heating furnace set at 300° C. for 15 minutes, to perform thermal extraction. After thermal extraction, GC-MS analysis of the components obtained is performed under the aforementioned measuring conditions, and the impurity component having main peaks at m/z=228, 186, 171, and 143 with a retention time in the total ion chromatogram in the range of 11.5 to 12.5 min (peak area value in the total ion chromatogram: S₁) is detected.

Further, as a control standard sample, an acetone solution of methyl 6-hydroxy-2-naphthoate with a predetermined concentration is prepared and poured into a measuring cup for thermal extraction GC-MS devices. In this situation, the poured volume of methyl 6-hydroxy-2-naphthoate is referred to as A₂ [μg]. Under the same conditions as in thermal extraction GC-MS analysis of the liquid crystal polyester, the solution is inserted into a pyrolysis heating furnace set at 300° C. for 15 minutes for thermal extraction. After thermal extraction, GC-MS analysis of the components obtained is performed under the aforementioned measuring conditions, and methyl 6-hydroxy-2-naphthoate having main peaks at m/z=202, 171, 143, 115, and 44 with a retention time in the total ion chromatogram of about 11.92 min (peak area value in the total ion chromatogram: S₂) is detected.

The relative content of the impurity component (X₂) [ppm] can be calculated from formula (2) below.

X₂=S₁×A₂/S₂/A₁×1000 (2)

According to the examples and comparative examples described later, the impurity component had a retention time of the peak top in the total ion chromatogram of 12.03 to 12.04 min. Nevertheless, the reason why the retention time of the impurity component is broadly specified in the range of 11.5 to 12.5 min is that, even if the measuring conditions of thermal extraction GC-MS are specified as described above, the retention time cannot be constant due to non-uniformity in temperature control, variations in the properties of individual columns, and the like. However, the peak in the total ion chromatogram of the impurity component can be easily specified in the retention time in the range of 11.5 to 12.5 min from the relationship between the main peaks at m/z=228, 186, 171, and 143 in the MS spectrum chart of the impurity component and the retention time of methyl 6-hydroxy-2-naphthoate as a control standard sample.

In the liquid crystal polyester of the embodiment, the relative content of the impurity component is 50 ppm or less, preferably 30 ppm or less, more preferably 20 ppm or less, further preferably 18 ppm or less, still more preferably 15 ppm or less. The content of the upper limit or less can suppress the coloration of the liquid crystal polyester more.

In the liquid crystal polyester of the embodiment, the relative content of the impurity component may be 5 ppm or more, 10 ppm or more, or 12 ppm or more, for it is easy to polymerize the liquid crystal polyester.

In the liquid crystal polyester of the embodiment, the relative content of the impurity component is preferably 5 ppm or more and 50 ppm or less, more preferably 10 ppm or more and 30 ppm or less, further preferably 12 ppm or more and 20 ppm or less, still more preferably 12 ppm or more and 18 ppm or less, particularly preferably 12 ppm or more and 15 ppm or less, for it is easy to polymerize the liquid crystal polyester.

The coloration of the liquid crystal polyester of the embodiment is suppressed. When the color values of the liquid crystal polyester are evaluated in the CIE LAB color space, the L* value is preferably 60 or more, more preferably 61 or more, further preferably 62 or more, and the a* value is preferably 6.0 or less, more preferably 5.5 or less, further preferably 5.0 or less.

When the color values of the liquid crystal polyester of the embodiment are evaluated in the CIE LAB color space, the L* value may be 100 or less, 90 or less, 80 or less, or 70 or less, and the a* value is 0.0 or more and may be 2.0 or more or 4.0 or more.

When the color values of the liquid crystal polyester of the embodiment are evaluated in the CIE LAB color space, the L* value may be 60 or more and 90 or less, 61 or more and 80 or less, or 62 or more and 70 or less, and the a* value may be 0.0 or more and 6.0 or less, 2.0 or more and 5.5 or less, or 4.0 or more and 5.0 or less.

The L* value and the a* value as the color values of the liquid crystal polyester are measured by sieving each powdery liquid crystal polyester with a 42-mesh (mesh opening: 355 μm) sieve, filling the liquid crystal polyester that has passed therethrough into a quartz cell, and using a colorimeter (e.g. “ZE-2000”, NIPPON DENSHOKU INDUSTRIES CO., LTD.) in the reflection mode.

The liquid crystal polyester of the embodiment is a powdery liquid crystal polyester. When the liquid crystal polyester does not pass through the 42-mesh (mesh opening: 355 μm) sieve, because of having a shape such as pellet shape, the liquid crystal polyester is freeze-ground using a freeze grinder, and the powdery liquid crystal polyester is then sieved by the aforementioned method. After that, measuring the color values of the L* value and a* value is carried out. As a freeze grinder, a ball mill freeze grinder (“JFC-1500”, manufactured by Japan Analytical Industry Co., Ltd.), for example, can be used. The freeze grinding conditions can be, for example, pellet input amount: 5 g, preliminary freezing time: 10 minutes, and freeze-grinding time: 10 minutes.

The chemical structure of the liquid crystal polyester of the embodiment is not limited, as long as it comprises a structural unit derived from 6-hydroxy-2-naphthoic acid as an aromatic hydroxycarboxylic acid.

Typical examples of the liquid crystal polyester of the embodiment include the followings:

1) Those obtained by polymerization (polycondensation) of only 6-hydroxy-2-naphthoic acid as an aromatic hydroxycarboxylic acid;
2) Those obtained by polymerization (polycondensation) of a plurality of aromatic hydroxycarboxylic acids including 6-hydroxy-2-naphthoic acid;
3) Those obtained by polymerization (polycondensation) of (i) an aromatic hydroxycarboxylic acid including 6-hydroxy-2-naphthoic acid, (ii) an aromatic dicarboxylic acid, and (iii) at least one compound selected from the group consisting of an aromatic diol, an aromatic hydroxyamine, and an aromatic diamine; and 4) Those obtained by polymerization (polycondensation) of (i) crystal polyester such as polyethylene terephthalate with 6-hydroxy-2-naphthoic acid.

Here, the 6-hydroxy-2-naphthoic acid, the aromatic hydroxycarboxylic acid, the aromatic dicarboxylic acid, the aromatic diol, the aromatic hydroxyamine, and the aromatic diamine are each independently optionally partially or fully substituted with a polymerizable derivative thereof.

Examples of the polymerizable derivative of 6-hydroxy-2-naphthoic acid include 6-acyloxy-2-naphthoic acid, 6-hydroxy-2-alkoxycarbonyl naphthalene, 6-hydroxy-2-aryloxycarbonyl naphthalene, 6-hydroxy-2-haloformylcarbonylnaphthalene, 6-acyloxy-2-alkoxycarbonyl naphthalene, 6-acyloxy-2-aryloxycarbonyl naphthalene, and 6-acyloxy-2-haloformylcarbonylnaphthalene.

Examples of divalent aromatic hydrocarbon groups contained as skeletons of the aromatic hydroxycarboxylic acid, the aromatic dicarboxylic acid, the aromatic diol, the aromatic hydroxyamine, and the aromatic diamine each independently include a phenylene group, a naphthylene group, and a biphenylylene group.

Examples of polymerizable derivatives with a compound having a carboxy group such as the aromatic hydroxycarboxylic acid and the aromatic dicarboxylic acid include those obtained by converting a carboxy group to an alkoxycarbonyl group or an aryloxycarbonyl group (esters), those obtained by converting a carboxy group to a haloformyl group (acid halides), and those obtained by converting a carboxy group to an acyloxycarbonyl group (acid anhydrides). Examples of polymerizable derivatives with a compound having a hydroxy group such as the aromatic hydroxycarboxylic acid, the aromatic diol, and the aromatic hydroxyamine include those obtained by acylating a hydroxy group into an acyloxy group (acylated products). Examples of polymerizable derivatives with a compound having an amino group such as the aromatic hydroxyamine and the aromatic diamine include those obtained by acylating an amino group into an acylamino group (acylated products).

The liquid crystal polyester of the embodiment preferably comprises a structural unit derived from 6-hydroxy-2-naphthoic acid, a structural unit derived from an aromatic dicarboxylic acid, and a structural unit (u3) represented by formula (3) below.

—X—Ar³—Y— (3)

In formula (3), Ar³ represents a 1,4-phenylene group or a 1,3-phenylene group, X represents —NH—, and Y represents —O— or —NH—. However, the hydrogen atoms of the group represented by Ar³ are each independently optionally replaced by a halogen atom, an alkyl group having a carbon number of 1 to 10, or an aryl group having a carbon number of 6 to 20.

A liquid crystal polyester amide comprising the structural unit (u3) represented by formula (3) has excellent adhesion to a metal material such as a copper foil.

The structural unit derived from the aromatic dicarboxylic acid preferably comprises a structural unit (u2) represented by formula (2) below:

—CO—Ar²—CO— (2)

wherein Ar² represents a 1,4-phenylene group, a 1,3-phenylene group, or a 2,6-naphthalenediyl group, provided that the hydrogen atoms of the group represented by Ar² are each independently optionally replaced by a halogen atom, an alkyl group having a carbon number of 1 to 10, or an aryl group having a carbon number of 6 to 20.

The Ar² is preferably 1,3-phenylene, Ar^{j} is preferably 1,4-phenylene, and Y is preferably —O—.

Here, examples of the halogen atom in Ar² and Ar³ include a fluorine atom, a chlorine atom, a bromine atom, and an iodine atom. Examples of the alkyl group include a methyl group, an ethyl group, a n-propyl group, an isopropyl group, a n-butyl group, an isobutyl group, a s-butyl group, a t-butyl group, a n-hexyl group, a 2-ethylhexyl group, a n-octyl group, and a n-decyl group, and the number of carbon atoms is generally 1 to 10. Examples of the aryl group include a phenyl group, an o-tolyl group, a m-tolyl group, a p-tolyl group, a 1-naphthyl group, and a 2-naphthyl group, and the number of carbon atoms is generally 6 to 20. When the hydrogen atoms are replaced by these groups, the number is generally each independently 2 or less, preferably 1 or less, for the group represented by Ar² or Ar³.

The content of the structural unit derived from 6-hydroxy-2-naphthoic acid in the liquid crystal polyester of the embodiment is preferably 20 mol % or more, more preferably 30 mol % or more, further preferably 40 mol % or more, per 100 mol % of the total amount of all structural units in the liquid crystal polyester.

The content of the structural unit derived from 6-hydroxy-2-naphthoic acid in the liquid crystal polyester is 100 mol % or less, preferably 90 mol % or less, more preferably 80 mol % or less, further preferably 70 mol % or less, per 100 mol % of the total amount of all structural units in the liquid crystal polyester. The content of the structural unit derived from 6-hydroxy-2-naphthoic acid of the aforementioned upper limit or less can ensure reaction stability in production of the liquid crystal polyester and can suppress coloration further

Examples of the numerical range of the content of the structural unit derived from 6-hydroxy-2-naphthoic acid may include 20 mol % or more and 100 mol % or less, 20 mol % or more and 90 mol % or less, 30 mol % or more and 80 mol % or less, or 40 mol % or more and 70 mol % or less.

When the liquid crystal polyester of the embodiment comprises the structural unit derived from the aromatic dicarboxylic acid, the content of the structural unit derived from the aromatic dicarboxylic acid is preferably 10 mol % or more, more preferably 15 mol % or more, further preferably 20 mol % or more, per 100 mol % of the total amount of all structural units in the liquid crystal polyester.

The content of the structural unit derived from the aromatic dicarboxylic acid in the liquid crystal polyester is preferably 40 mol % or less, more preferably 35 mol % or less, further preferably 30 mol % or less, per 100 mol % of the total amount of all structural units in the liquid crystal polyester.

Examples of the numerical range of the content of the structural unit derived from the aromatic dicarboxylic acid may include 10 mol % or more and 40 mol % or less, 15 mol % or more and 35 mol % or less, or 20 mol % or more and 30 mol % or less.

When the liquid crystal polyester of the embodiment comprises the structural unit (u2) represented by formula (2), the content of the structural unit (u2) represented by formula (2) is preferably 10 mol % or more, more preferably 15 mol % or more, further preferably 20 mol % or more, per 100 mol % of the total amount of all structural units in the liquid crystal polyester.

The content of the structural unit (u2) represented by formula (2) in the liquid crystal polyester is preferably 40 mol % or less, more preferably 35 mol % or less, further preferably 30 mol % or less, per 100 mol % of the total amount of all structural units in the liquid crystal polyester.

Examples of the numerical range of the content of the structural unit (u2) represented by formula (2) above may include 10 mol % or more and 40 mol % or less, 15 mol % or more and 35 mol % or less, or 20 mol % or more and 30 mol % or less.

When the liquid crystal polyester of the embodiment comprises the structural unit (u3) represented by formula (3), the content of the structural unit (u3) represented by formula (3) is preferably 10 mol % or more, more preferably 15 mol % or more, further preferably 20 mol % or more, per 100 mol % of the total amount of all structural units in the liquid crystal polyester.

The content of the structural unit (u3) represented by formula (3) in the liquid crystal polyester is preferably 40 mol % or less, more preferably 35 mol % or less, further preferably 30 mol % or less, per 100 mol % of the total amount of all structural units in the liquid crystal polyester.

Examples of the numerical range of the content of the structural unit (u3) represented by formula (3) above may include 10 mol % or more and 40 mol % or less, 15 mol % or more and 35 mol % or less, or 20 mol % or more and 30 mol % or less.

However, the total amount of all structural units in the liquid crystal polyester does not exceed 100 mol %.

In the liquid crystal polyester, the content of the structural unit (2) and the content of the structural unit (3) are preferably equal. The difference between the content of the structural unit (2) and the content of the structural unit (3) is preferably 0 mol % or more and 5 mol % or less, more preferably 0 mol % or more and 4 mol % or less, further preferably 0 mol % or more and 3 mol % or less.

The flow initiation temperature of the liquid crystal polyester of the embodiment is preferably 250° C. or more, more preferably 260° C. or more, further preferably 280° C. or more.

The flow initiation temperature of the liquid crystal polyester of the embodiment is preferably 350° C. or less, more preferably 340° C. or less, further preferably 330° C. or less.

The flow initiation temperature of the liquid crystal polyester of the embodiment is more preferably 250° C. or more and 350° C. or less, more preferably 260° C. or more and 340° C. or less, further preferably 280° C. or more and 330° C. or less.

As the flow initiation temperature of the liquid crystal polyester of the embodiment increases, the heat resistance, the strength, and the rigidity of the liquid crystal polyester tends to be improved more. Meanwhile, the flow initiation temperature of the liquid crystal polyester of over 350° C. tends to increase the melting temperature and the melt viscosity of the liquid crystal polyester. Therefore, the melting temperature of the liquid crystal polyester of the upper limit or less allows a temperature necessary for molding the liquid crystal polyester to be set low.

In this description, the flow initiation temperature of the liquid crystal polyester is also called flow temperature or fluidization temperature and is a temperature that serves as a measure of the molecular weight of the liquid crystal polyester (see “Liquid crystal Polymer-Synthesis, Molding, and Application”, edited by Naoyuki Koide, CMC Publishing Co., Ltd., Jun. 5, 1987, p. 95). The flow initiation temperature is a temperature exhibiting a viscosity of 4800 Pa·s (48000 poise) when the liquid crystal polyester is melted while being heated at a rate of 4° C./min under a load of 9.8 MPa (100 kg/cm²) using a capillary rheometer and extruded from a nozzle with an inner diameter of 1 mm and a length of 10 mm.

The liquid crystal polyester of the embodiment has the following aspects.

“1”: A liquid crystal polyester comprising a structural unit derived from 6-hydroxy-2-naphthoic acid, wherein
in thermal extraction GC-MS analysis of the liquid crystal polyester under the following measuring conditions, the relative content of an impurity component determined from the GC peak area in the total ion chromatogram using methyl 6-hydroxy-2-naphthoate as a standard sample is 50 ppm or less, preferably 30 ppm or less, more preferably 20 ppm or less, further preferably 18 ppm or less, even more preferably 15 ppm or less, based on the mass of the liquid crystal polyester, and
the impurity component has main peaks at m/z=228, 186, 171, and 143 in the MS spectrum chart and a retention time detected in the range of 11.5 to 12.5 min in the total ion chromatogram:

### (Measuring Conditions of Thermal Extraction GC-MS)

Thermal extraction temperature: 300° C. for 15 min;
ITF temperature: 320° C.;
Column: 0.25 mm diameter×30 m (stationary phase: 5% diphenyl dimethyl polysiloxane, film thickness: 0.25 μm);
Inlet temperature: 320° C.;
Split ratio: 100:1;
Oven temperature: 50° C. (1 min), 20° C./min, then 350° C. (5 min);
Carrier gas: Helium at 103.3 mL/min;
Electron ionization energy: 1435 eV;
Measuring mass range: m/z 35 to 600;
MS interface temperature: 350° C.; and
Solvent waiting time: 4 min.
“2”: The liquid crystal polyester according to “1” above, wherein the relative content of the impurity component is preferably 5 ppm or more, more preferably 10 ppm or more, further preferably 12 ppm or more, based on the mass of the liquid crystal polyester.
“3”: The liquid crystal polyester according to “1” or “2” above, further comprising a structural unit derived from an aromatic dicarboxylic acid, and a structural unit (u3) represented by formula (3) below:

—X—Ar³—Y— (3)

wherein Ar³ preferably represents a 1,4-phenylene group or a 1,3-phenylene group, more preferably a 1,4-phenylene group, X represents —NH—, Y preferably represents —O— or —NH—, more preferably-O—, provided that the hydrogen atoms of the group represented by Ar³ are each independently optionally replaced by a halogen atom, an alkyl group having a carbon number of 1 to 10, or an aryl group having a carbon number of 6 to 20.
“4”: The liquid crystal polyester according to “3” above, wherein the structural unit derived from the aromatic dicarboxylic acid comprises the structural unit (u2) represented by formula (2) below:

—CO—Ar²—CO— (2)

wherein Ar² preferably represents a 1,4-phenylene group, a 1,3-phenylene group, or a 2,6-naphthalenediyl group, more preferably a 1,3-phenylene group, provided that the hydrogen atoms of the group represented by Ar² are each independently optionally replaced by a halogen atom, an alkyl group having a carbon number of 1 to 10, or an aryl group having a carbon number of 6 to 20.
“5”: The liquid crystal polyester according to “4” above, wherein the Ar² is 1,3-phenylene, Ar³ is 1,4-phenylene, and Y is —O—.
“6”: The liquid crystal polyester according to any one of “1” to “5” above, wherein when the color values of the liquid crystal polyester are evaluated in the CIE LAB color space, the L* value is 60 or more, preferably 61 or more, more preferably 62 or more.
“7”: The liquid crystal polyester according to “6” above, wherein when the color values of the liquid crystal polyester are evaluated in the CIE LAB color space, the L* value is 100 or less, the L* value may be 90 or less, 80 or less, or 70 or less.
“8”: The liquid crystal polyester according to any one of “1” to “7” above, wherein when the color values of the liquid crystal polyester are evaluated in the CIE LAB color space, the a* value is 6.0 or less, preferably 5.5 or less, more preferably 5.0 or less.
“9”: The liquid crystal polyester according to “8” above, wherein when the color values of the liquid crystal polyester are evaluated in the CIE LAB color space, the a* value may be 0.0 or more, 2.0 or more, or 4.0 or more.
“10”: The liquid crystal polyester according to any one of “1” to “9” above, wherein the content of the structural unit derived from 6-hydroxy-2-naphthoic acid in the liquid crystal polyester is 20 mol % or more, preferably 30 mol % or more, more preferably 40 mol % or more, per 100 mol % of the total amount of all structural units in the liquid crystal polyester.
“11”: The liquid crystal polyester according to any one of “1” to “10” above, wherein the content of the structural unit derived from 6-hydroxy-2-naphthoic acid in the liquid crystal polyester is 100 mol % or less, preferably 90 mol % or less, more preferably 80 mol % or less, further preferably 70 mol % or less, per 100 mol % of the total amount of all structural units in the liquid crystal polyester.
“12”: The liquid crystal polyester according to any one of “1” to “11” above, wherein the content of the structural unit derived from the aromatic dicarboxylic acid in the liquid crystal polyester is 10 mol % or more, preferably 15 mol % or more, more preferably 20 mol % or more, per 100 mol % of the total amount of all structural units in the liquid crystal polyester.
“13”: The liquid crystal polyester according to any one of “1” to “12” above, wherein the content of the structural unit derived from the aromatic dicarboxylic acid in the liquid crystal polyester is 40 mol % or less, preferably 35 mol % or less, more preferably 30 mol % or less, per 100 mol % of the total amount of all structural units in the liquid crystal polyester.
“14”: The liquid crystal polyester according to any one of “1” to “13” above, wherein the content of the structural unit (u2) represented by formula (2) in the liquid crystal polyester is 10 mol % or more, preferably 15 mol % or more, more preferably 20 mol % or more, per 100 mol % of the total amount of all structural units in the liquid crystal polyester.
“15”: The liquid crystal polyester according to any one of “1” to “14” above, wherein the content of the structural unit (u2) represented by formula (2) in the liquid crystal polyester is 40 mol % or less, preferably 35 mol % or less, more preferably 30 mol % or less, per 100 mol % of the total amount of all structural units in the liquid crystal polyester.
“16”: The liquid crystal polyester according to any one of “1” to “15” above, wherein the content of the structural unit (u3) represented by formula (3) in the liquid crystal polyester is 10 mol % or more, preferably 15 mol % or more, more preferably 20 mol % or more, per 100 mol % of the total amount of all structural units in the liquid crystal polyester.
“17”: The liquid crystal polyester according to any one of “1” to “16” above, wherein the content of the structural unit (u3) represented by formula (3) in the liquid crystal polyester is 40 mol % or less, preferably 35 mol % or less, more preferably 30 mol % or less, per 100 mol % of the total amount of all structural units in the liquid crystal polyester.
“18”: The liquid crystal polyester according to any one of “1” to “17” above, wherein the difference between the content of the structural unit (2) and the content of the structural unit (3) in the liquid crystal polyester is 0 mol % or more and 5 mol % or less, preferably 0 mol % or more and 4 mol % or less, more preferably 0 mol % or more and 3 mol % or less.
“19”: The liquid crystal polyester according to any one of “1” to “18” above, wherein the liquid crystal polyester has a flow initiation temperature of 250° C. or more, preferably 260° C. or more, more preferably 280° C. or more.
“20”: The liquid crystal polyester according to any one of “1” to “19” above, wherein the liquid crystal polyester has a flow initiation temperature of 350° C. or less, preferably 340° C. or less, more preferably 330° C. or less.

### <Method for Producing Liquid Crystal Polyester>

The method for producing the liquid crystal polyester of the embodiment is not specifically limited.

The liquid crystal polyester of the embodiment can be produced by a method for producing a liquid crystal polyester, comprising melt polycondensation of monomers that provide structural units.

According to the method for producing the liquid crystal polyester of the embodiment, a liquid crystal polyester in which coloration is suppressed can be produced.

As the monomers, ester-forming derivatives are preferably used, in order to allow the melt polycondensation to proceed rapidly and suppress the coloration of the liquid crystal polyester.

Further, the liquid crystal polyester of the embodiment can be produced by a method for producing a liquid crystal polyester, comprising step (ii) of obtaining a liquid crystal polyester by transesterification reaction of an acylated product of 6-hydroxy-2-naphthoic acid and a carboxylic anhydride for melt polycondensation.

Further, the liquid crystal polyester of the embodiment can be produced by a method for producing a liquid crystal polyester, comprising step (i) of obtaining an acylated product by acylation reaction of monomers comprising 6-hydroxy-2-naphthoic acid or its ester-forming derivative with a carboxylic anhydride and step (ii) of obtaining a liquid crystal polyester by transesterification reaction of the acylated product for melt polycondensation.

Further, the liquid crystal polyester of the embodiment can be produced by a method for producing a liquid crystal polyester, comprising step (i) of obtaining an acylated product by acylation reaction of monomers comprising 6-hydroxy-2-naphthoic acid with a carboxylic anhydride and step (ii) of obtaining a liquid crystal polyester by transesterification reaction of the acylated product for melt polycondensation.

Further, the liquid crystal polyester of the embodiment can be produced by a method for producing a liquid crystal polyester, comprising step (i) of obtaining an acylated product by acylation reaction of 6-hydroxy-2-naphthoic acid or its ester-forming derivative, at least one compound selected from the group consisting of an aromatic hydroxyamine, an aromatic diamine, and an aromatic diol, or its ester-forming derivative, and a carboxylic anhydride and step (ii) of obtaining a liquid crystal polyester by transesterification reaction of the acylated product with an aromatic dicarboxylic acid for melt polycondensation.

Further, the liquid crystal polyester of the embodiment can be produced by a method for producing a liquid crystal polyester, comprising step (i) of obtaining an acylated product by further acylation reaction of 6-hydroxy-2-naphthoic acid, an aromatic hydroxyacyl amide compound represented by formula (4) below, and a carboxylic anhydride and step (ii) of obtaining a liquid crystal polyester by transesterification reaction of the acylated product with an aromatic dicarboxylic acid for melt polycondensation.

R—NH—Ar³—OH (4)

In formula (4), R represents an alkyl group having a carbon number of 1 to 10, and Ar³ represents a 1,4-phenylene group or a 1,3-phenylene group, provided that the hydrogen atoms of the group represented by Ar³ are each independently optionally replaced by a halogen atom, an alkyl group having a carbon number of 1 to 10, or an aryl group having a carbon number of 6 to 20.

Examples of the ester-forming derivative of a compound having a carboxyl group such as an aromatic hydroxycarboxylic acid and an aromatic dicarboxylic acid include those in which the carboxyl group is converted to a haloformyl group, those in which the carboxyl group is converted to an acyloxycarbonyl group, and those in which the carboxyl group is converted to an alkoxycarbonyl group or an aryloxycarbonyl group.

Further, examples of the ester-forming derivative of a compound having a hydroxyl group such as an aromatic hydroxycarboxylic acid and an aromatic diol include those in which the hydroxyl group is converted to an acyloxy group. Among them, those in which the hydroxyl group is converted to an acyloxy group are preferably used, that is, an aromatic acyloxycarboxylic acid in which the hydroxyl group is acylated is preferably used as the ester-forming derivative of the aromatic hydroxycarboxylic acid, and further an aromatic hydroxyacyloxy compound or an aromatic diacyloxy compound in which the hydroxyl group is acylated is preferably used as the ester-forming derivative of the aromatic diol.

Further, examples of the ester-forming derivative of a compound having an amino group such as an aromatic hydroxyamine and an aromatic diamine include those in which the amino group is converted to an acylamino group. Among them, those in which the hydroxyl group is converted to an acyloxy group are preferably used, that is, an aromatic hydroxyacyl amide compound in which the hydroxyl group is acylated is preferably used as the ester-forming derivative of the aromatic hydroxyamine, and further an aromatic diacylamino compound in which the amino group is acylated is preferably used as the ester-forming derivative of the aromatic diamine.

The acylation is preferably acetylation with an acetic anhydride, and the ester-forming derivative by the acetylation can be subjected to deacetic acid polycondensation.

In general, the acetic anhydride is added in excess of the total equivalent amount of the hydroxyl group and the amino group in the raw material monomers in the acetylation with an acetic anhydride, in order to allow the acetylation reaction to proceed rapidly so as to reduce the slurry concentration of the reaction system. However, if the acetic anhydride is excessively added until an appropriate slurry concentration, the liquid crystal polyester to be obtained is yellowed due to the side reaction, though the acetylation reaction rapidly proceeds.

In step (i), the 6-hydroxy-2-naphthoic acid or its ester-forming derivative, or the at least one compound selected from the group consisting of an aromatic hydroxyamine, an aromatic diamine, and an aromatic diol or its ester-forming derivative are preferably ester-forming derivatives in which at least some of the hydroxyl groups or the amino groups are acylated. This can reduce the amount of the carboxylic anhydride mixed and can suppress the yellowing of the liquid crystal polyester to be obtained.

Examples of the ester-forming derivatives in which some of the hydroxyl groups or the amino groups are acylated include an aromatic hydroxyacyloxy compound, an aromatic acyloxyamine compound, an aromatic hydroxyacyl amide compound, and an aromatic aminoacylamide compound.

Examples of the ester-forming derivatives in which all hydroxyl groups and amino groups are acylated include 6-acyloxy-2-naphthoic acid, 6-acyloxy-2-alkoxycarbonyl naphthalene, 6-acyloxy-2-aryloxycarbonyl naphthalene, 6-acyloxy-2-haloformylcarbonylnaphthalene, an aromatic acyloxycarboxylic acid, an aromatic diacyloxy compound, an aromatic acyloxyacyl amide compound, and an aromatic diacyl amide compound. However, the case where all the raw material monomers are ester-forming derivatives in which all hydroxyl groups and amino groups are acylated in step (i) above is excluded.

In step (i) above, it is preferable to comprise a monocarboxylic acid in acylation with a carboxylic anhydride. Comprising a monocarboxylic acid can reduce the excess amount of the carboxylic anhydride mixed and can suppress the yellowing of the liquid crystal polyester to be obtained, as well as reducing the slurry concentration and appropriately adjusting the slurry concentration.

The monocarboxylic acid may be a saturated fatty acid such as formic acid, acetic acid, propionic acid, butyric acid, valeric acid, and caproic acid, an unsaturated fatty acid such as oleic acid, linoleic acid, and linolenic acid, or an aromatic carboxylic acid such as benzoic acid.

In step (i) above, it is preferable to add acetic acid in acetylation with an acetic anhydride. Addition of acetic acid can reduce the slurry concentration and appropriately adjust the slurry concentration, as well as reducing the excess amount of an acetic anhydride mixed and suppressing the yellowing of the liquid crystal polyester to be obtained.

In step (i) above, the amount of the carboxylic anhydride mixed is preferably 102 equivalent parts or more, more preferably 105 equivalent parts or more, further preferably 110 equivalent parts or more, per 100 equivalent parts of the total of hydroxyl groups and amino groups in all monomers in the acylation reaction system. The amount of the lower limit or more can allow the acylation reaction to rapidly proceed.

In step (i) above, the amount of the carboxylic anhydride mixed is preferably 117 equivalent parts or less, more preferably 115 equivalent parts or less, further preferably 113 equivalent parts or less, per 100 equivalent parts of the total of hydroxyl groups and amino groups in all monomers in the acylation reaction system. The amount of the upper limit or less can suppress the coloration of the liquid crystal polyester to be obtained.

In step (i) above, the amount of the carboxylic anhydride mixed is preferably 102 equivalent parts or more and 117 equivalent parts or less, more preferably 105 equivalent parts or more and 115 equivalent parts or less, further preferably 110 equivalent parts or more and 113 equivalent parts or less, per 100 equivalent parts of the total of hydroxyl groups and amino groups in all monomers in the acylation reaction system.

When the monocarboxylic acid is mixed in step (i) above, the amount of the monocarboxylic acid mixed is preferably 5 molar parts or more, more preferably 10 molar parts or more, further preferably 15 molar parts or more, per 100 molar parts of the carboxylic anhydride. The amount of the lower limit or more can suppress the coloration of the liquid crystal polyester to be obtained.

When the monocarboxylic acid is mixed in step (i) above, the amount of the monocarboxylic acid mixed is preferably 80 molar parts or less, more preferably 70 molar parts or less, further preferably 60 molar parts or less, per 100 molar parts of the carboxylic anhydride. The amount of the upper limit or less can allow the acylation reaction to rapidly proceed.

When the monocarboxylic acid is mixed in step (i) above, the amount of the monocarboxylic acid mixed is preferably 5 molar parts or more and 80 molar parts or less, more preferably 10 molar parts or more and 70 molar parts or less, further preferably 15 molar parts or more and 60 molar parts or less, per 100 molar parts of the carboxylic anhydride.

The melt polycondensation may be performed in the presence of a catalyst, and examples of the catalyst include metal compounds such as magnesium acetate, stannous acetate, tetrabutyl titanate, lead acetate, sodium acetate, potassium acetate, and antimony trioxide, and nitrogen-comprising heterocyclic compounds such as 4-(dimethylamino)pyridine and 1-methylimidazole. Nitrogen-comprising heterocyclic compounds are preferably used. The melt polycondensation may further include solid-phase polymerization, as required.

The method for producing a liquid crystal polyester of the embodiment has the following aspects.

“51”: The method for producing the liquid crystal polyester according to any one of “1” to “20” above, comprising step (ii) of obtaining a liquid crystal polyester by transesterification reaction of an acylated product of 6-hydroxy-2-naphthoic acid and a carboxylic anhydride for melt polycondensation.
“52”: The method for producing the liquid crystal polyester according to “51” above, comprising step (i) of obtaining an acylated product by acylation reaction of monomers comprising 6-hydroxy-2-naphthoic acid or its ester-forming derivative with a carboxylic anhydride and step (ii) of obtaining a liquid crystal polyester by transesterification reaction of the acylated product for melt polycondensation.
“53”: The method for producing the liquid crystal polyester according to “52” above, comprising step (i) of obtaining an acylated product by acylation reaction of monomers comprising 6-hydroxy-2-naphthoic acid with a carboxylic anhydride and step (ii) of obtaining a liquid crystal polyester by transesterification reaction of the acylated product for melt polycondensation.
“54”: The method for producing the liquid crystal polyester according to any one of “51” to “53” above, comprising step (i) of obtaining an acylated product by acylation reaction of 6-hydroxy-2-naphthoic acid or its ester-forming derivative, at least one compound selected from the group consisting of an aromatic hydroxyamine, an aromatic diamine, and an aromatic diol or its ester-forming derivative, and a carboxylic anhydride and step (ii) of obtaining a liquid crystal polyester by transesterification reaction of the acylated product with an aromatic dicarboxylic acid for melt polycondensation.
“55”: The method for producing the liquid crystal polyester according to “54” above, comprising step (i) of obtaining an acylated product by acylation reaction of 6-hydroxy-2-naphthoic acid or its ester-forming derivative, an ester-forming derivative of at least one compound selected from the group consisting of an aromatic hydroxyamine, an aromatic diamine, and an aromatic diol, and a carboxylic anhydride and step (ii) of obtaining a liquid crystal polyester by transesterification reaction of the acylated product with an aromatic dicarboxylic acid for melt polycondensation.
“56”: The method for producing the liquid crystal polyester according to “55” above, comprising step (i) of obtaining an acylated product by further acylation reaction of 6-hydroxy-2-naphthoic acid, an aromatic hydroxyacyl amide compound represented by formula (4) below, and a carboxylic anhydride and step (ii) of obtaining a liquid crystal polyester by transesterification reaction of the acylated product with an aromatic dicarboxylic acid for melt polycondensation:

R—NH—Ar³—OH (4)

wherein R represents an alkyl group having a carbon number of 1 to 10, preferably an alkyl group having a carbon number of 1 to 4, more preferably an alkyl group having a carbon number of 1 to 2, further preferably a methyl group, and Ar³ represents a 1,4-phenylene group or a 1,3-phenylene group, provided that the hydrogen atoms of the group represented by Ar³ are each independently optionally replaced by a halogen atom, an alkyl group having a carbon number of 1 to 10, or an aryl group having a carbon number of 6 to 20.
“57”: The method for producing the liquid crystal polyester according to any one of “52” to “56” above, wherein a monocarboxylic acid is mixed in step (i) above.
“58”: The method for producing the liquid crystal polyester according to “57” above, wherein the monocarboxylic acid is a saturated fatty acid such as formic acid, acetic acid, propionic acid, butyric acid, valeric acid, and caproic acid, unsaturated fatty acid such as oleic acid, linoleic acid, and linolenic acid, or an aromatic carboxylic acid such as benzoic acid, preferably, a saturated fatty acid such as formic acid, acetic acid, propionic acid, butyric acid, valeric acid, and caproic acid, more preferably acetic acid.
“59”: The method for producing the liquid crystal polyester according to “57” or “58” above, wherein the carboxylic anhydride is preferably a saturated fat acid anhydride, more preferably an acetic anhydride.
“60”: The method for producing the liquid crystal polyester according to any one of “57” to “59” above, wherein the amount of the carboxylic acid mixed in step (i) above is 102 equivalent parts or more, preferably 105 equivalent parts or more, more preferably 110 equivalent parts or more, per 100 equivalent parts of the total of hydroxyl groups and amino groups in all monomers in the acylation reaction system.
“61”: The method for producing the liquid crystal polyester according to any one of “57” to “60” above, wherein the amount of the carboxylic acid mixed in step (i) above is 117 equivalent parts or less, preferably 115 equivalent parts or less, more preferably 113 equivalent parts or less, per 100 equivalent parts of the total of hydroxyl groups and amino groups in all monomers in the acylation reaction system.
“62”: The method for producing the liquid crystal polyester according to any one of “57” to “61” above, wherein the amount of the carboxylic acid mixed in step (i) above is 5 molar parts or more, preferably 10 molar parts or more, more preferably 15 molar parts or more, per 100 molar parts of the carboxylic anhydride.
“63”: The method for producing the liquid crystal polyester according to any one of “57” to “62” above, wherein the amount of the carboxylic acid mixed in step (i) above is 80 molar parts or less, preferably 70 molar parts or less, more preferably 60 molar parts or less, per 100 molar parts of the carboxylic anhydride.

### <Liquid Crystal Polyester Film>

The liquid crystal polyester film of the embodiment is a liquid crystal polyester film comprising a structural unit derived from 6-hydroxy-2-naphthoic acid, a structural unit derived from an aromatic dicarboxylic acid, and a structural unit (u3) represented by formula (3) below, wherein when the color values of the liquid crystal polyester film are evaluated in the CIE LAB color space, the L* value is 60 or more, and the a* value is 9.0 or less:

—X—Ar³—Y— (3)

wherein Ar³ represents a 1,4-phenylene group or a 1,3-phenylene group, X represents —NH—, and Y represents —O— or —NH—, provided that the hydrogen atoms of the group represented by Ar³ are each independently optionally replaced by a halogen atom, an alkyl group having a carbon number of 1 to 10, or an aryl group having a carbon number of 6 to 20.

The liquid crystal polyester film of the embodiment can be obtained by molding the liquid crystal polyester of the embodiment as it is into a film. Accordingly, the liquid crystal polyester film of the embodiment can have the same composition and the same properties such as the flow initiation temperature, as the liquid crystal polyester of the embodiment.

The coloration of the liquid crystal polyester film of the embodiment is suppressed. When the color values of the liquid crystal polyester film are evaluated in the CIE LAB color space, the L* value is preferably 60 or more, more preferably 61 or more, further preferably 62 or more, and the a* value is preferably 6.5 or less, more preferably 6.0 or less, further preferably 5.5 or less.

When the color values of the liquid crystal polyester film of the embodiment are evaluated in the CIE LAB color space, the L* value is 100 or less, and the L* value may be 90 or less, 80 or less, or 70 or less, and the a* value is 0.0 or more and may be 2.0 or more or 4.0 or more.

When the color values of the liquid crystal polyester film of the embodiment are evaluated in the CIE LAB color space, the L* value may be 60 or more and 90 or less, 61 or more and 80 or less, or 62 or more and 70 or less, and the a* value may be 0.0 or more and 6.0 or less, 2.0 or more and 5.5 or less, or 4.0 or more and 5.0 or less.

The color values of the liquid crystal polyester film, the L* value and the a* value, are measured, using a colorimeter (e.g., “ZE-2000”, NIPPON DENSHOKU INDUSTRIES CO., LTD.) in the reflection mode, by placing each liquid crystal polyester film on a standard white plate.

In the liquid crystal polyester film of the embodiment, the structural unit derived from the aromatic dicarboxylic acid preferably comprises the structural unit (u2) represented by formula (2) below.

—CO—Ar²—CO— (2)

In formula (2), Ar² represents a 1,4-phenylene group, a 1,3-phenylene group, or a 2,6-naphthalenediyl group. However, the hydrogen atoms of the group represented by Ar² are each independently optionally replaced by a halogen atom, an alkyl group having a carbon number of 1 to 10, or an aryl group having a carbon number of 6 to 20.

In the liquid crystal polyester film of the embodiment, it is preferable that the Ar² is 1,3-phenylene, Ar³ is 1,4-phenylene, and Y is —O—.

Although the thickness of the liquid crystal polyester film of the embodiment is not specifically limited, the thickness is preferably 10 μm or more, more preferably 15 μm or more, further preferably 20 μm or more, particularly preferably 25 μm or more, in order to ensure the film strength.

The thickness of the liquid crystal polyester film of the embodiment is preferably 50 μm or less, more preferably 45 μm or less, further preferably 40 μm or less, particularly preferably 35 μm or less.

The thickness of the liquid crystal polyester film of the embodiment is preferably 10 μm or more and 50 μm or less, more preferably 15 μm or more and 45 μm or less, further preferably 20 μm or more and 40 μm or less, particularly preferably 25 μm or more and 35 μm or less.

The tensile strength of the liquid crystal polyester film of the embodiment is preferably 90 MPa or more, more preferably 100 MPa or more, further preferably 110 MPa or more.

The tensile strength of the liquid crystal polyester film of the embodiment may be 155 MPa or less, 150 MPa or less, or 145 MPa or less.

The tensile strength of the liquid crystal polyester film of the embodiment is preferably 90 MPa or more and 155 MPa or less, more preferably 100 MPa or more and 150 MPa or less, further preferably 110 MPa or more and 145 MPa or less.

The tensile modulus of the liquid crystal polyester film of the embodiment is preferably 4.2 GPa or more, more preferably 4.5 GPa or more, further preferably 4.8 GPa or more.

The tensile modulus of the liquid crystal polyester film of the embodiment may be 6.1 GPa or less, 5.8 GPa or less, or 5.5 GPa or less.

The tensile modulus of the liquid crystal polyester film of the embodiment is preferably 4.2 GPa or more and 6.1 GPa or less, more preferably 4.5 GPa or more and 5.8 GPa or less, further preferably 4.8 GPa or more and 5.5 GPa or less.

The tensile strength strain of the liquid crystal polyester film of the embodiment is preferably 10.0% or more, more preferably 12.0% or more, further preferably 14.0% or more.

The tensile strength strain of the liquid crystal polyester film of the embodiment may be 40.0% or less, 20.0% or less, or 16.0% or less.

The tensile modulus of the liquid crystal polyester film of the embodiment is preferably 10.0% or more and 40.0% or less, more preferably 12.0% or more and 20.0% or less, further preferably 14.0% or more and 16.0% or less.

The liquid crystal polyester film was cut into a dumbbell-shaped No. 3 test piece with a parallel part width of 5 mm and a distance between gauge lines of 20 mm based on JIS K6251, to measure the tensile strength, the tensile modulus, and the tensile strength strain of the liquid crystal polyester film according to JIS K7161 using a tensile tester at a tensile speed of 5 mm/min.

The liquid crystal polyester film of the embodiment can be suitably used for applications including films for electronic parts such as printed wiring boards and speaker diaphragms. The liquid crystal polyester film of the embodiment can be provided as a substrate (e.g., flexible substrate), a laminate (e.g., flexible copper-clad laminate), a printed substrate, a printed wiring board, a printed circuit board, or the like, which have the film as an insulating material.

The liquid crystal polyester film of the embodiment can be used for applications such as a multilayer printed circuit board and a flexible printed wiring board while being laminated on the support, depending on the purpose. Further, the liquid crystal polyester film of the embodiment can be used as an insulating film or the like by separating or removing the support, depending on the purpose.

The liquid crystal polyester film of the embodiment has the following aspects.

“101”: A liquid crystal polyester film comprising: a structural unit derived from 6-hydroxy-2-naphthoic acid, a structural unit derived from an aromatic dicarboxylic acid, and a structural unit (u3) represented by formula (3) below, wherein when the color values of the liquid crystal polyester film are evaluated in the CIE LAB color space, the L* value is 60 or more, preferably 61 or more, more preferably 62 or more, and the a* value is 9.0 or less:

—X—Ar³—Y— (3)

wherein Ar³ represents a 1,4-phenylene group or a 1,3-phenylene group, X represents —NH—, and Y represents —O— or —NH—, provided that the hydrogen atoms of the group represented by Ar³ are each independently optionally replaced by a halogen atom, an alkyl group having a carbon number of 1 to 10, or an aryl group having a carbon number of 6 to 20.
“102”: The liquid crystal polyester film according to “101” above, wherein when the color values of the liquid crystal polyester film are evaluated in the CIE LAB color space, the L* value is 100 or less, and the L* value may be 90 or less, 80 or less, or 70 or less. “103”: The liquid crystal polyester film according to “101” or “102” above, wherein when the color values of the liquid crystal polyester film are evaluated in the CIE LAB color space, the a* value is 6.0 or less, preferably 5.5 or less, more preferably 5.0 or less.
“104”: The liquid crystal polyester film according to any one of “101” to “103” above, wherein when the color values of the liquid crystal polyester film are evaluated in the CIE LAB color space, the a* value may be 0.0 or more, 2.0 or more, or 4.0 or more.
“105”: The liquid crystal polyester film according to any one of “101” to “104” above, wherein the structural unit derived from the aromatic dicarboxylic acid comprises a structural unit (u2) represented by formula (2) below:

—CO—Ar²—CO— (2)

wherein Ar² represents a 1,4-phenylene group, a 1,3-phenylene group, or a 2,6-naphthalenediyl group, provided that the hydrogen atoms of the group represented by Ar² are each independently optionally replaced by a halogen atom, an alkyl group having a carbon number of 1 to 10, or an aryl group having a carbon number of 6 to 20.
“106”: The liquid crystal polyester film according to “105” above, wherein the Ar² is 1,3-phenylene, Ar³ is 1,4-phenylene, and Y is —O—.
“107”: The liquid crystal polyester film according to any one of “101” to “106” above, wherein the content of the structural unit derived from 6-hydroxy-2-naphthoic acid in the liquid crystal polyester film is 20 mol % or more, preferably 30 mol % or more, more preferably 40 mol or more, per 100 mol % of the total amount of all structural units in the liquid crystal polyester film.
“108”: The liquid crystal polyester film according to any one of “101” to “107” above, wherein the content of the structural unit derived from 6-hydroxy-2-naphthoic acid in the liquid crystal polyester film is 100 mol % or less, preferably 90 mol % or less, more preferably 80 mol % or less, further preferably 70 mol % or less, per 100 mol % of the total amount of all structural units in the liquid crystal polyester film.
“109”: The liquid crystal polyester film according to any one of “101” to “108” above, wherein the content of the structural unit derived from the aromatic dicarboxylic acid in the liquid crystal polyester film is 10 mol % or more, preferably 15 mol % or more, more preferably 20 mol % or more, per 100 mol % of the total amount of all structural units in the liquid crystal polyester film.
“110”: The liquid crystal polyester film according to any one of “101” to “109” above, wherein the content of the structural unit derived from the aromatic dicarboxylic acid in the liquid crystal polyester film is 40 mol % or less, preferably 35 mol % or less, more preferably 30 mol % or less, per 100 mol % of the total amount of all structural units in the liquid crystal polyester film.
“111”: The liquid crystal polyester film according to any one of “101” to “110” above, wherein the content of the structural unit (u2) represented by formula (2) in the liquid crystal polyester film is 10 mol % or more, preferably 15 mol % or more, more preferably 20 mol % or more, per 100 mol % of the total amount of all structural units in the liquid crystal polyester film.
“112”: The liquid crystal polyester film according to any one of “101” to “111” above, wherein the content of the structural unit (u2) represented by formula (2) in the liquid crystal polyester film is 40 mol % or less, preferably 35 mol % or less, more preferably 30 mol % or less, per 100 mol % of the total amount of all structural units in the liquid crystal polyester film.
“113”: The liquid crystal polyester film according to any one of “101” to “112” above, wherein the content of the structural unit (u3) represented by formula (3) in the liquid crystal polyester film is 10 mol % or more, preferably 15 mol % or more, more preferably 20 mol % or more, per 100 mol % of the total amount of all structural units in the liquid crystal polyester film.
“114”: The liquid crystal polyester film according to any one of “101” to “113” above, wherein the content of the structural unit (u3) represented by formula (3) in the liquid crystal polyester film is 40 mol % or less, preferably 35 mol % or less, more preferably 30 mol % or less, per 100 mol % of the total amount of all structural units in the liquid crystal polyester film.
“115”: The liquid crystal polyester film according to any one of “101” to “114” above, wherein the difference between the content of the structural unit (2) and the content of the structural unit (3) in the liquid crystal polyester film is 0 mol % or more and 5 mol % or less, preferably 0 mol % or more and 4 mol % or less, more preferably 0 mol % or more and 3 mol % or less.
“116”: The liquid crystal polyester film according to any one of “101” to “115” above, wherein the flow initiation temperature of the liquid crystal polyester film is 250° C. or more, preferably 260° C. or more, more preferably 280° C. or more.
“117”: The liquid crystal polyester film according to any one of “101” to “116” above, wherein the flow initiation temperature of the liquid crystal polyester film is 350° C. or less, preferably 340° C. or less, more preferably 330° C. or less.
“118”: The liquid crystal polyester film according to any one of “101” to “117” above, wherein the thickness of the liquid crystal polyester film is 10 μm or more, preferably 15 μm or more, more preferably 20 μm or more, further preferably 25 μm or more.
“119”: The liquid crystal polyester film according to any one of “101” to “118” above, wherein the thickness of the liquid crystal polyester film is 50 μm or less, preferably 45 μm or less, more preferably 40 μm or less, further preferably 35 μm or less.

### <Method for Producing Liquid Crystal Polyester Film>

The method for producing the liquid crystal polyester film of the embodiment is not specifically limited.

The liquid crystal polyester film of the embodiment can be produced by a method for producing a liquid crystal polyester film, comprising casting a liquid composition comprising the liquid crystal polyester and a solvent to dissolve the liquid crystal polyester into a film form and then removing the solvent from the liquid composition.

According to the method for producing the liquid crystal polyester film of the embodiment, a liquid crystal polyester film in which coloration is suppressed can be produced.

Further, the liquid crystal polyester film of the embodiment can be produced by a method for producing a liquid crystal polyester film, comprising casting a liquid composition comprising the liquid crystal polyester and a solvent to dissolve the liquid crystal polyester onto a support and then removing the solvent from the liquid composition.

Examples of the solvent include halogenated hydrocarbons such as dichloromethane, chloroform, 1,1-dichloroethane, 1,2-dichloroethane, 1,1,2,2-tetrachloroethane, 1-chlorobutane, chlorobenzene, and o-dichlorobenzene; halogenated phenols such as p-chlorophenol, pentachlorophenol, and pentafluorophenol; ethers such as diethyl ether, tetrahydrofuran, and 1,4-dioxane; ketones such as acetone and cyclohexanone; esters such as ethyl acetate and γ-butyrolactone; carbonates such as ethylene carbonate and propylene carbonate; amines such as triethylamine; nitrogen-comprising heterocyclic aromatic compounds such as pyridine; nitriles such as acetonitrile and succinonitrile; amides such as N,N-dimethylformamide, N,N-dimethylacetamide, and N-methylpyrrolidone; urea compounds such as tetramethylurea; nitro compounds such as nitromethane and nitrobenzene; sulfur compounds such as dimethylsulfoxide and sulfolane; and phosphorus compounds such as hexamethyl phosphate amide and tri-n-butyl phosphate. Two or more of them may be used.

As the solvent, in view of low corrosiveness and ease of handling, a solvent comprising an aprotic solvent as the main component, particularly a solvent comprising a halogen-free aprotic polar solvent as the main component is preferred. In this description, the “main component” refers to a component that accounts for 50 mass % or more of 100 mass % of the total. The ratio of the halogen-free aromatic polar solvent to 100 mass % of the entire solvent is preferably 50 to 100 mass %, more preferably 70 to 100 mass %, further preferably 90 to 100 mass %. Further, as the halogen-free aromatic polar solvent, amides such as N,N-dimethylformamide, N,N-dimethylacetamide, tetramethylurea, and N-methylpyrrolidone or esters such as γ-butyrolactone are preferably used, and N,N-dimethylformamide, N,N-dimethylacetamide, and N-methylpyrrolidone are further preferably used.

Further, as the solvent, a solvent comprising a compound with a boiling point of 220° C. or less as the main component under 1 atm is preferable, for it is easy to remove the solvent. The ratio of the compound with a boiling point of 220° C. or less under 1 atm to 100 mass % of the entire solvent is preferably 50 to 100 mass %, more preferably 70 to 100 mass %, further preferably 90 to 100 mass %. As the halogen-free aprotic polar solvent, a compound with a boiling point of 220° C. or less under 1 atm is preferably used.

The ratio of the liquid crystal polyester contained in the liquid composition is preferably 0.1 to 60 mass %, more preferably 1 to 50 mass %, further preferably 3 to 40 mass %, particularly preferably 5 to 30 mass %, to the total amount of the liquid crystal polyester and the solvent.

The liquid composition may comprise one or more other components such as a filler, an additive, and a resin other than the liquid crystal polyester.

Examples of the filler include inorganic fillers such as silica, alumina, titanium oxide, barium titanate, strontium titanate, aluminum hydroxide, and calcium carbonate; and organic fillers such as a curing epoxy resin, a crosslinked benzoguanamine resin, and a crosslinked acrylic resin. The content thereof may be 0 parts by mass and is preferably 100 parts by mass or less per 100 parts by mass of the liquid crystal polyester.

Examples of the additive include a leveling agent, a defoamer, an antioxidant, an ultraviolet absorber, a flame retardant, and a colorant. The content thereof may be 0 parts by mass and is preferably 5 parts by mass or less per 100 parts by mass of the liquid crystal polyester.

The liquid composition can be obtained by mixing the liquid crystal polyester, a solvent, and other components, as required at one time or in a suitable order, to prepare a mixed solution, followed by filtration with a filter or the like, as required, to remove fine foreign matter contained in the mixed solution.

The viscosity of the liquid composition is not specifically limited but is preferably 2000 mPa·s or less, more preferably 1500 mPa·s or less, further preferably 1000 mPa·s or less, for casting work is carried out easily.

In this description, the viscosity of the liquid composition is measured at 23° C. using a B-type viscometer.

The viscosity of the liquid composition is preferably 200 mPa·s or more, more preferably 250 mPa·s or more, further preferably 300 mPa·s or more, for drying work is carried out in a short time.

The viscosity of the liquid composition is preferably 200 mPa·s or more and 2000 mPa·s or less, more preferably 250 mPa·s or more and 1500 mPa·s or less, further preferably 300 mPa·s or more and 1000 mPa·s or less.

Examples of the method for casting the liquid composition into a film form include casting methods onto a support by various means such as roller coating, dip coating, spray coating, spinner coating, curtain coating, slot coating, and screen printing.

Further, the method for removing the solvent is not specifically limited but is preferably performed by evaporation of the solvent. Examples of the method for evaporating the solvent include methods such as heating, pressure reduction, and ventilation. Among them, evaporation by heating is preferable, in view of production efficiency and handleability, and evaporation by heating under ventilation is more preferable. Examples of the heating conditions at this time preferably include a step of pre-drying at 30 to 200° C. for 10 minutes to 6 hours and a step of heat treatment at 200 to 400° C. for 30 minutes to 5 hours.

The method for producing the liquid crystal polyester film of the embodiment has the following aspects.

“151”: A method for producing a liquid crystal polyester film, comprising casting a liquid composition comprising the liquid crystal polyester according to any one of “1” to “20” above and a solvent to dissolve the liquid crystal polyester into a film form and then removing the solvent from the liquid composition.
“152”: A method for producing a liquid crystal polyester film, comprising casting a liquid composition comprising the liquid crystal polyester according to any one of “1” to “20” above and a solvent to dissolve the liquid crystal polyester onto a support and then removing the solvent from the liquid composition.
“153”: The method for producing a liquid crystal polyester film according to “151” or “152” above, wherein the solvent is preferably a solvent comprising an aprotic solvent as the main component, more preferably a solvent comprising a halogen-free aromatic polar solvent as the main component.
“154”: The method for producing a liquid crystal polyester film according to any one of “151” to “153” above, wherein the viscosity of the liquid composition is 2000 mPa·s or less, preferably 1500 mPa·s or less, more preferably 1000 mPa·s or less.
“155”: The method for producing a liquid crystal polyester film according to any one of “151” to “154” above, wherein the viscosity of the liquid composition is 200 mPa·s or more, preferably 250 mPa·s or more, more preferably 300 mPa·s or more.

### EXAMPLES

Hereinafter, the present invention will be described further in detail by way of specific examples. However, the present invention is not limited to the examples shown below at all.

### <Production of Liquid Crystal Polyester>

### Example 1

940.9 g (5.0 mol) of 6-hydroxy-2-naphthoic acid, 377.9 g (2.5 mol) of 4-hydroxyacetanilide, 415.3 g (2.5 mol) of isophthalic acid, 867.8 g (8.4 mol) of acetic anhydride, and 90 g (1.5 mol) of acetic acid were put into a reactor provided with a stirring device, a torque meter, a nitrogen gas inlet tube, a thermometer, and a reflux condenser, and the gas in the reactor was replaced with nitrogen gas. Thereafter, under nitrogen gas stream, the temperature was raised from room temperature to 140° C. over 60 minutes with stirring, and refluxing at 140° C. for 3 hours was carried out. Then, while distilling off acetic acid as a by-product and unreacted acetic anhydride, the temperature was raised from 150° C. to 300° C. over 5 hours and held at 300° C. for 30 minutes, and the content was taken out from the reactor, followed by cooling to room temperature. The solid product obtained was ground with a grinder manufactured by Orient Mill Co., Ltd. (model: VM-16, rotational speed: 1500 rpm), to obtain a powdery liquid crystal polyester (A1).

To conduct solid-phase polymerization, the temperature of the liquid crystal polyester (A1) was raised from room temperature to 160° C. over 2 hours and 20 minutes under a nitrogen atmosphere, then raised from 160° C. to 180° C. over 3 hours and 20 minutes, and held at 180° C. for 5 hours followed by cooling. Then, it was ground with a grinder manufactured by Orient Mill Co., Ltd. (model: VM-16, rotational speed: 1500 rpm) using a perforated metal screen with a mesh opening of 4 mm, to obtain a powdery liquid crystal polyester (B1).

To conduct solid-phase polymerization, the temperature of the liquid crystal polyester (B1) was raised from room temperature to 180° C. over 1 hour and 25 minutes under a nitrogen atmosphere, then raised from 180° C. to 255° C. at a heating rate of 0.2° C./min, and held at 255° C. for 5 hours followed by cooling, to obtain a powdery liquid crystal polyester (C1). The flow initiation temperature of the liquid crystal polyester (C1) of Example 1 was 300.3° C.

### Example 2

A powdery liquid crystal polyester (A2), a powdery liquid crystal polyester (B2) and a powdery liquid crystal polyester (C2) were obtained in the same manner as in Example 1 except that 90 g (1.5 mol) of acetic acid put into the reactor in Example 1 was changed to acetic acid 180 g (3.0 mol). The flow initiation temperature of the liquid crystal polyester (C2) of Example 2 was 299.9° C.

### Example 3

A powdery liquid crystal polyester (A3), a powdery liquid crystal polyester (B3), and a powdery liquid crystal polyester (C3) were obtained in the same manner as in Example 1 except that 90 g (1.5 mol) of acetic acid put into the reactor in Example 1 was changed to 270 g (4.5 mol) of acetic acid. The flow initiation temperature of the liquid crystal polyester (C3) of Example 3 was 298.4° C.

### Example 4

A powdery liquid crystal polyester (A4), a powdery liquid crystal polyester (B4), and a powdery liquid crystal polyester (C4) were obtained in the same manner as Example 1 except that 90 g (1.5 mol) of acetic acid put into the reactor in Example 1 was not put. The flow initiation temperature of the liquid crystal polyester (C4) of Example 4 was 302.7° C.

### Comparative Example 1

A powdery liquid crystal polyester (A5), a powdery liquid crystal polyester (B5), and a powdery liquid crystal polyester (C5) were obtained in the same manner as Example 1 except that 867.8 g (8.4 mol) of acetic anhydride put into the reactor in Example 1 was changed to 957.8 g (9.3 mol) of acetic anhydride, and 90 g (1.5 mol) of acetic acid put into the reactor was not put. The flow initiation temperature of the liquid crystal polyester (C5) of Comparative Example 1 was 315.5° C.

### Comparative Example 2

A powdery liquid crystal polyester (A6), a powdery liquid crystal polyester (B6), and a powdery liquid crystal polyester (C6) were obtained in the same manner as Example 1 except that 867.8 g (8.4 mol) of acetic anhydride put into the reactor in Example 1 was changed to 1047.8 g (10.2 mol) of acetic anhydride, and 90 g (1.5 mol) of acetic acid put into the reactor was not put. The flow initiation temperature of the liquid crystal polyester (C6) of Comparative Example 1 was 316.5° C.

### (Measuring of Flow Initiation Temperature of Liquid Crystal Polyester)

Using a flow examiner (“CFT-500 type”, SHIMADZU CORPORATION), a cylinder to which a die having a nozzle with an inner diameter of 1 mm and a length of 10 mm was attached was filled with about 2 g of the powdery liquid crystal polyester of each of Examples 1 to 4 and Comparative Examples 1 and 2, and the liquid crystal polyester was melted under a load of 9.8 MPa (100 kg/cm²), while the temperature was raised at a rate of 4° C./min, and extruded from the nozzle, to measure the temperature (flow initiation temperature) at which the melt viscosity was 4800 Pa·s (48000 P).

### (Measurement of Color Values of Liquid Crystal Polyester)

The L* value and the a* value were measured by sieving the powdery liquid crystal polyester of each of Examples 1 to 4 and Comparative Examples 1 and 2 with a 42-mesh (mesh opening: 355 μm) sieve, filling the liquid crystal polyester that had passed therethrough into a quartz cell, and using a colorimeter (“ZE-2000”, NIPPON DENSHOKU INDUSTRIES CO., LTD.) in the reflection mode. Table 1 shows the results of measuring the L* value and the a* value of the liquid crystal polyester of each of Examples 1 to 4 and Comparative Examples 1 and 2.

### (Thermal Extraction GC-MS Analysis of Liquid Crystal Polyester)

Using a thermal extraction GC-MS device (gas chromatograph: HP6890, manufactured by Agilent Technologies Japan, Ltd., mass spectrometer: 5973N, manufactured by Agilent Technologies Japan, Ltd., pyrolysis heating furnace: PY-2020D, manufactured by Frontier Laboratories Ltd.), thermal extraction GC-MS analysis was performed on the powdery liquid crystal polyester of each of Examples 1 to 4 and Comparative Examples 1 and 2 under the following conditions.

### (Measuring Conditions of Thermal Extraction GC-MS)

Thermal extraction temperature: 300° C. for 15 min
ITF temperature: 320° C.
Column: UA5, manufactured by Frontier Laboratories Ltd.,
0.25 mm diameter×30 m (stationary phase: 5% diphenyl dimethyl polysiloxane, film thickness: 0.25 μm)
Inlet temperature: 320° C.
Split ratio: 100:1
Oven temperature: 50° C. (1 min), 20° C./min, then 350° C. (5 min)
Carrier gas: Helium at 103.3 mL/min
Electron ionization energy: 1435 eV
Measuring mass range: m/z 35 to 600
MS interface temperature: 350° C.

For example, 20.2 mg (weighing value: A₁) of the liquid crystal polyester (C1) of Example 1 was weighed, poured into a measuring cup for thermal extraction GC-MS device, and inserted into a pyrolysis heating furnace set at 300° C. for 15 minutes, to perform thermal extraction. After thermal extraction, the components obtained were subjected to GC-MS analysis, and impurity components having the main peaks at m/z=228, 186, 171, and 143 with a retention time of 12.03 min in the total ion chromatogram were detected.

The powdery liquid crystal polyesters (C1) to (C6) of Examples 1 to 4 and Comparative Examples 1 and 2 were subjected to thermal extraction GC-MS analysis 3 times for each.

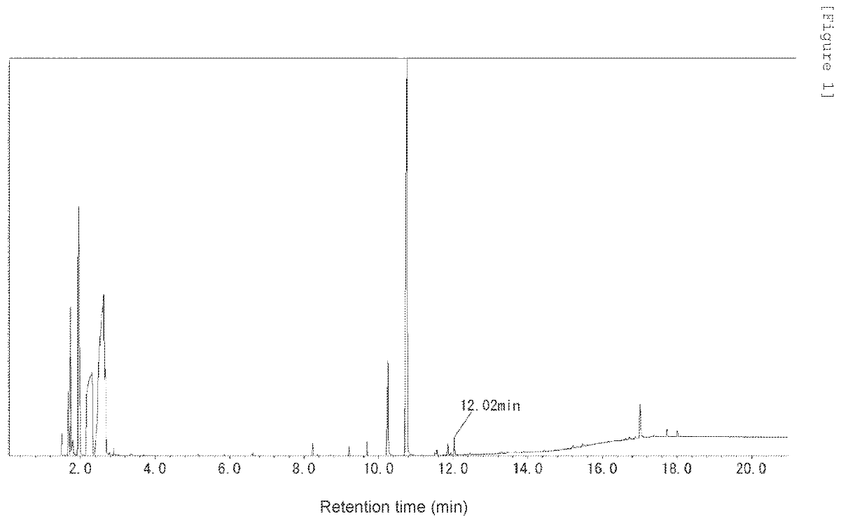

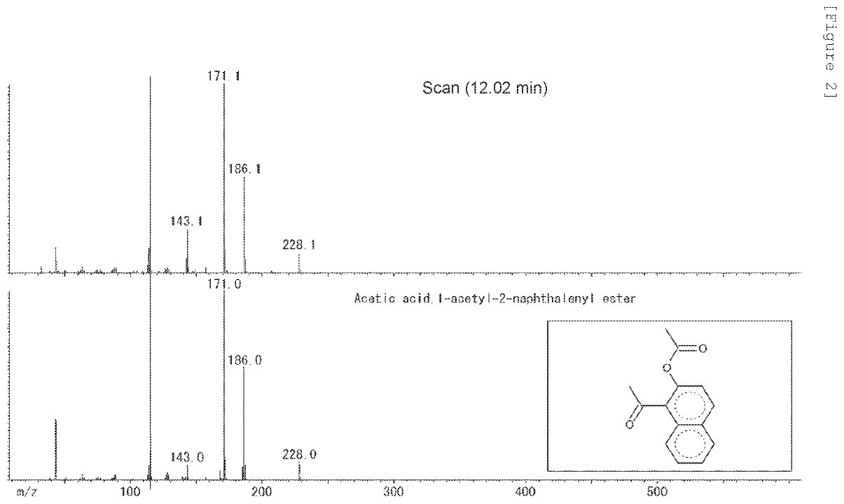

Among these, FIG. 1 shows a total ion chromatogram in thermal extraction GC-MS analysis of the liquid crystal polyester of Example 4. Further, FIG. 2 (upper) shows the MS spectrum at an elution time of 12.02 min in the total ion chromatogram in thermal extraction GC-MS analysis of the liquid crystal polyester of Example 4. FIG. 2 (lower) shows the MS spectrum of the standard sample of 1-acetyl-2-acetoxynaphthalene.

In the MS spectrum (FIG. 2 (upper)) at an elution time of 12.02 min, the peak at m/z=228.1 detected on the highest mass side is consistent with the molecular weights of 1-acetyl-2-acetoxynaphthalene (Mw=228) and 2-acetyl-6-acetoxynaphthalene (Mw=228).

The fact that the peaks were detected at m/z=228.1, 186.1, 171.1, and 143.1 in the MS spectrum of FIG. 2 (upper) is consistent with the MS pattern of 1-acetyl-2-acetoxynaphthalene (Mw=228) in FIG. 2 (lower). Accordingly, the impurity component is presumed to be 1-acetyl-2-acetoxynaphthalene (Mw=228), 2-acetyl-6-acetoxynaphthalene (Mw=228), or an isomer having the same molecular weight as above.

It is considered that since the acetoxy group was directly bonded to the naphthalene ring, O═C═CH₂ (Mw=42) was eliminated and a peak at m/z=186 was detected like 2-hydroxy-1-acetyl naphthalene (Mw=186) and 6-hydroxy-1-acetyl naphthalene (Mw=186).

It is considered that since CH₃ group (Mw=15) was further eliminated because of the presence of the acetyl group, the peak at m/z=171 was remarkably detected. Further, it is considered that since the C═O group (Mw=28) was eliminated, the peak at m/z=143 was detected.

In the total ion chromatogram obtained by thermal extraction GC-MS analyses of the powdery liquid crystal polyesters (C1) to (C6) of Examples 1 to 4 and Comparative Examples 1 and 2, all of the largest GC peaks (peak top retention time: 12.03 to 12.04 min) had main peaks at m/z=228, 186, 171, and 143 in the MS spectrum among the GC peaks detected in a retention time in the range of 11.5 to 12.5 min. None of other GC peaks with a retention time in the range of 11.5 to 12.5 min had main peaks at m/z=228, 186, 171, and 143 in the MS spectrum.

From the results of Thermal extraction GC-MS analysis of the liquid crystal polyesters of Examples 1 to 4 and Comparative Examples 1 and 2, a component having the peak at m/z=188 with a retention time of 11.8 min was detected as a component that could be 6-hydroxy-2-naphthoic acid (Mw=188) as a raw material monomer. However, the content had no correlation with polymer coloration.

A component corresponding to 6-acetoxy-2-naphthoic acid (Mw=230) as a raw material monomer was not detected in the analysis in the SIM mode from any of the liquid crystal polyesters of Examples 1 to 4 and Comparative Examples 1 and 2.

### (Method for Calculating Relative Content of Impurity Component in Thermal Extract of Liquid Crystal Polyester)

Using methyl 6-hydroxy-2-naphthoate as a control standard sample, the relative content of the impurity component in the GC peak having main peaks at m/z=228, 186, 171, and 143 in the MS spectrum chart and a retention time detected in the range of 11.5 to 12.5 min in the total ion chromatogram based on the mass of each liquid crystal polyester was quantified by the following calculation method.

Methyl 6-hydroxy-2-naphthoate was dissolved in acetone to prepare standard sample acetone solutions of various concentrations. Each standard sample acetone solution was poured into a measuring cup for thermal extraction GC-MS device, and the cup was inserted into a pyrolysis heating furnace set at 300° C. for 15 minutes for thermal extraction. After thermal extraction, GC-MS analysis was performed on the component obtained.

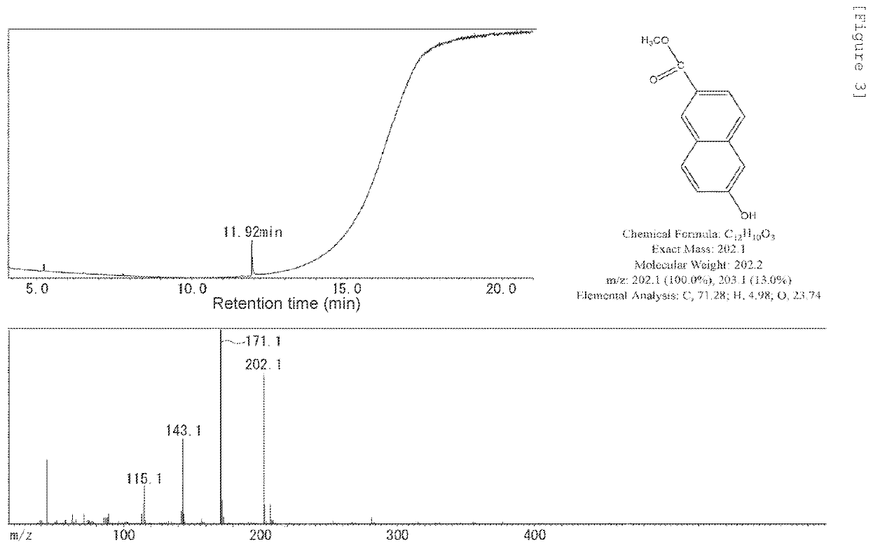

FIG. 3 includes a total ion chromatogram (upper) and an MS spectrum (lower) in thermal extraction GC-MS analysis of methyl 6-hydroxy-2-naphthoate.

An MS spectrum having main peaks at m/z=202, 171, 143, and 115 with a retention time of 11.92 min was detected in the total ion chromatogram.

Further, the ratio of the peak area value S₂ with a retention time of 11.92 min in the total ion chromatogram to the injection volume (A₂) [μg] of methyl 6-hydroxy-2-naphthoate as a control standard sample into the measuring cup (S₂/A₂), as determined by the least-squares method, was 2.0×10⁷.

For example, when 20.2 mg (weighing value: A₁) of the liquid crystal polyester (C1) of Example 1 was weighed and subjected to thermal extraction GC-MS analysis, the peak area value S₁ of the impurity component was 6833345. Accordingly, the relative content of the impurity component X₁ [μg] was calculated by formula (1) below to be 0.342 μg, and the relative content of the impurity component (X₂) [ppm] was calculated by formula (2) below to be 17 ppm, based on the mass of the liquid crystal polyester.

X₁=S₁×A₂/S₂ (1)

x₂=S₁×A₂/S₂/A₁×1000 (2)

Likewise, the relative content (X₂) [ppm] of the impurity component in thermal extraction GC-MS analysis of each of the powdery liquid crystal polyesters (C1) to (C6) of Examples 1 to 4 and Comparative Examples 1 and 2 was determined from the 3 times of thermal extraction GC-MS analyses for each, to calculate an average. Table 1 shows the results.

In Examples 1 to 4, the relative content of the impurity component was 50 ppm or less based on the mass of the liquid crystal polyester, whereas in Comparative Examples 1 and 2, the relative content of the impurity component was over 50 ppm based on the mass of the liquid crystal polyester.

It was found from the results of Examples 1 to 4 and Comparative Examples 1 and 2 that the relative content of the impurity component had a strong correlation with the degree of coloration of the liquid crystal polyester. That is, as the relative content of the impurity component decreased, the coloration of the liquid crystal polyester tended to be suppressed more, and when the color values of the liquid crystal polyester were evaluated in the CIE LAB color space, the L* value tended to increase, and the a* value tended to decrease.

### <Production of Liquid Crystal Polyester Film>

### (Preparation of Liquid Crystal Polyester Liquid Composition)

Eight parts by mass of each of the powdery liquid crystal polyesters (C1) to (C6) of Examples 1 to 4 and Comparative Examples 1 and 2 were added to 92 parts by mass of N-methylpyrrolidone (boiling point (1 atm): 204° C.) and stirred at 140° C. for 4 hours under a nitrogen atmosphere, to prepare a liquid crystal polyester liquid composition, respectively

### (Viscosity Measurement of Liquid Crystal Polyester Liquid Composition)

The viscosity of the liquid crystal polyester liquid composition at 23° C. was measured using a B-type viscometer (“TV-22”, Toki Sangyo Co., Ltd). Table 1 shows the viscosity of the liquid crystal polyester liquid composition.

### (Production of Liquid Crystal Polyester Film)

Each liquid crystal polyester liquid composition was casted onto a roughened surface of a copper foil (3EC-VLP 18 μm, manufactured by MITSUI MINING & SMELTING CO., LTD.) for a casting film having a thickness of 300 μm, using a film applicator with a micrometer (“SA204”, TQC Sheen) and an automatic coating apparatus (“Type I”, TESTER SANGYO CO., LTD.), to obtain a casting film. Thereafter, the solvent was partially removed by drying the casting film at 40° C. at a normal pressure (1 atm) for 4 hours, to obtain a casting film with a thickness of 300 μm. Further, the second casting was performed for a casting film having a thickness of 300 μm from above the casting film with the solvent removed, and the solvent was partially removed by drying the casting film at 40° C. at a normal pressure (1 atm) for 4 hours, to obtain a casting film with a thickness of 300 μm×2=600 μm. The temperature of the film with a copper foil after drying was further raised in a hot air oven under a nitrogen atmosphere from room temperature to 310° C. over 4 hours, and the temperature was held for 2 hours for heat treatment. As a result, a heat-treated film with a copper foil was obtained. The copper foil of the film with a copper foil was removed by etching using a ferric chloride aqueous solution, to produce a single-layer liquid crystal polyester film. Table 1 shows the thickness of each single-layer liquid crystal polyester film.

### (Tensile Test of Liquid Crystal Polyester Film)

Each single-layer liquid crystal polyester film was cut into a dumbbell-shaped No. 3 test piece with a parallel part width of 5 mm and a distance between gauge lines of 20 mm based on JIS K6251.

Then, a tensile test was performed according to JIS K7161 using a tensile tester (autograph AG-IS, manufactured by SHIMADZU CORPORATION) at a tensile speed of 5 mm/min.

In any case, no clear yield point was observed, and the tensile strength, the tensile modulus, and the tensile strength strain of the liquid crystal polyester film could be determined. Table 1 shows the results.

### (Measurement of Color Values of Liquid Crystal Polyester Film)

The single-layer liquid crystal polyester film obtained was placed on a standard white board, and the L* value and the a* value were measured using a colorimeter (“ZE-2000”, NIPPON DENSHOKU INDUSTRIES CO., LTD.) in the reflection mode. Table 1 shows the measuring results.

It was found from the results of Examples 1 to 4 and Comparative Examples 1 and 2 that the relative content of the impurity component had a strong correlation with the degree of coloration of the liquid crystal polyester film. That is, as the relative content of the impurity component decreased, the coloration of the liquid crystal polyester film was suppressed more, and when the color values of the liquid crystal polyester film was evaluated in the CIE LAB color space, the L* value tended to increase, and the a* value tended to decrease.

TABLE 1

| | | | Example | Example | Example | Example | Comparative | Comparative |
|---|---|---|---|---|---|---|---|---|
| | | | 1 | 2 | 3 | 4 | Example 1 | Example 2 |
| Amount | 6-Hydroxy-2-naphthoate | mol | 5.0 | 5.0 | 5.0 | 5.0 | 5.0 | 5.0 |
| charged in | 4-Hydroxyacetanilide | mol | 2.5 | 2.5 | 2.5 | 2.5 | 2.5 | 2.5 |
| polymerization | Isophthalic acid | mol | 2.5 | 2.5 | 2.5 | 2.5 | 2.5 | 2.5 |
| reaction | Acetic anhydride | mol | 8.4 | 8.4 | 8.4 | 8.4 | 9.3 | 10.2 |
| | Acetic acid | mol | 1.5 | 3.0 | 4.5 | 0.0 | 0.0 | 0.0 |
| Liquid crystal | Flow initiation temperature | ° C. | 300.3 | 299.9 | 298.4 | 302.7 | 315.5 | 316.5 |
| polyester | L* value | | 63.9 | 64.4 | 65.0 | 65.3 | 49.7 | 39.5 |
| | a* value | | 4.2 | 4.2 | 4.0 | 4.3 | 6.4 | 6.9 |
| Impurity | Retention time | min | 12.03 | 12.03 | 12.03 | 12.03 | 12.04 | 12.04 |
| component | Relative content | ppm | 14 | 15 | 14 | 18 | 57 | 113 |
| Viscosity of liquid composition | | mPa · s | 626 | 544 | 333 | 651 | 513 | 606 |
| Liquid crystal | Thickness | μm | 26 | 30 | 26 | 25 | 25 | 25 |
| polyester film | Tensile strength | MPa | 122 | 130 | 131 | 131 | 131 | 135 |
| | Tensile modulus | GPa | 5.0 | 5.1 | 5.2 | 5.3 | 5.1 | 4.7 |
| | Tensile strength strain | % | 15.4 | 14.9 | 14.8 | 15.1 | 9.9 | 8.4 |

| | | | | | | |
|---|---|---|---|---|---|---|
| L* value | 67.5 | 68.0 | 68.6 | 64.1 | 53.2 | 48.0 |
| a* value | 4.4 | 3.6 | 3.2 | 6.3 | 9.3 | 9.1 |

1. A liquid crystal polyester comprising a structural unit derived from 6-hydroxy-2-naphthoic acid, wherein
in thermal extraction GC-MS analysis of the liquid crystal polyester under the following measuring conditions, the relative content of an impurity component determined from the GC peak area in the total ion chromatogram using methyl 6-hydroxy-2-naphthoate as a standard sample is 50 ppm or less based on the mass of the liquid crystal polyester, and
the impurity component has main peaks at m/z=228, 186, 171, and 143 in the MS spectrum chart and a retention time detected in the range of 11.5 to 12.5 min in the total ion chromatogram:
(Measuring conditions of thermal extraction GC-MS)
Thermal extraction temperature: 300° C. for 15 min;
ITF temperature: 320° C.;
Column: 0.25 mm diameter×30 m (stationary phase: 5% diphenyl dimethyl polysiloxane, film thickness: 0.25 μm);
Inlet temperature: 320° C.;
Split ratio: 100:1;
Oven temperature: 50° C. (1 min), 20° C./min, then 350° C. (5 min);
Carrier gas: Helium at 103.3 mL/min;
Electron ionization energy: 1435 eV;
Measuring mass range: m/z 35 to 600;
MS interface temperature: 350° C.; and
Solvent waiting time: 4 min.

2. The liquid crystal polyester according to claim 1, further comprising
a structural unit derived from an aromatic dicarboxylic acid and a structural unit (u3) represented by formula (3) below:
—X—Ar³—Y— (3)
wherein Ar³ represents a 1,4-phenylene group or a 1,3-phenylene group, X represents —NH—, and Y represents —O— or —NH—, provided that the hydrogen atoms of the group represented by Ar³ are each independently optionally replaced by a halogen atom, an alkyl group having a carbon number of 1 to 10, or an aryl group having a carbon number of 6 to 20.

3. The liquid crystal polyester according to claim 2, wherein
the structural unit derived from the aromatic dicarboxylic acid comprises a structural unit (u2) represented by formula (2) below:
—CO—Ar²—CO— (2)
wherein Ar² represents a 1,4-phenylene group, a 1,3-phenylene group, or a 2,6-naphthalenediyl group, provided that the hydrogen atoms of the group represented by Ar² are each independently optionally replaced by a halogen atom, an alkyl group having a carbon number of 1 to 10, or an aryl group having a carbon number of 6 to 20.

4. The liquid crystal polyester according to claim 3, wherein the Ar² is 1,3-phenylene, Ar³ is 1,4-phenylene, and Y is —O—.

5. A liquid crystal polyester film comprising
a structural unit derived from 6-hydroxy-2-naphthoic acid,
a structural unit derived from an aromatic dicarboxylic acid, and
a structural unit (u3) represented by formula (3) below, wherein
when the color values of the liquid crystal polyester film are evaluated in the CIE LAB color space, the L* value is 60 or more, and the a* value is 9.0 or less:
—X—Ar³—Y— (3)
wherein Ar³ represents a 1,4-phenylene group or a 1,3-phenylene group, X represents —NH—, and Y represents —O— or —NH—, provided that the hydrogen atoms of the group represented by Ar³ are each independently optionally replaced by a halogen atom, an alkyl group having a carbon number of 1 to 10, or an aryl group having a carbon number of 6 to 20.

6. The liquid crystal polyester film according to claim 5, wherein
the structural unit derived from the aromatic dicarboxylic acid comprises the structural unit (u2) represented by formula (2) below:
—CO—Ar²—CO— (2)
wherein Ar² represents a 1,4-phenylene group, a 1,3-phenylene group, or a 2,6-naphthalenediyl group, provided that the hydrogen atoms of the group represented by Ar² are each independently optionally replaced by a halogen atom, an alkyl group having a carbon number of 1 to 10, or an aryl group having a carbon number of 6 to 20.

7. The liquid crystal polyester film according to claim 6, wherein the Ar² is 1,3-phenylene, Ar³ is 1,4-phenylene, and Y is —O—.
